(19) United States
(12) Patent Application Publication
(10) Pub. No.: US 2021/0076176 A1
(43) Pub. Date: Mar. 11, 2021

(54) WIRELESS SYSTEM FOR MONITORING VIBRATORY SCREEN PERFORMANCE USING AN ENERGY HARVESTING SYSTEM

(71) Applicant: Weir Slurry Group, Inc., Fort Worth, TX (US)

(72) Inventor: Eric DeWilde, Milton, MI (US)

(21) Appl. No.: 16/959,933

(22) PCT Filed: Jan. 4, 2019
(86) PCT No.: PCT/US2019/012350

§ 371 Date: Jul. 2, 2020

Related U.S. Application Data
(60) Provisional application No. 62/614,246, filed on Jan. 5, 2018.

(51) Int. Cl. H04W 4/38; H02J 50/00; H02J 9/06; G01K 13/00; G01P 15/00; H04B 1/02

(52) U.S. Cl. CPC H04W 4/38; H02J 50/001; H04B 1/02; G01K 13/00; G01P 15/00; H02J 9/06

(57) ABSTRACT

A wireless sensor is disclosed for monitoring the health and performance of vibratory screen systems. Systems and techniques disclosed herein generate power from the vibrations of a vibratory screen system, selectable switch between a plurality of power sources, and strategically control voltage input and power expenditures to prolong the life of a measuring module while avoiding power cables and battery replacements. Avoiding power cables and battery replacements provides measuring modules that perform well in the harsh environment of a vibratory screen system because power cable destruction is avoided and battery swapping caused operational shutdowns are circumvented.

### RELATED APPLICATIONS

This application claims the benefit of International Application No. PCT/US2019/012350, filed Jan. 4, 2019 and entitled “Wireless System for Monitoring Vibratory Screen Performance Using an Energy Harvesting System,” which claims the benefit from and priority to U.S. Patent Provisional Application No. 62/614,246 that was filed on Jan. 5, 2018 and entitled “Wireless System for Monitoring Vibratory Screen Performance Using an Energy Harvesting System.” Both of these applications are incorporated by reference herein.

### TECHNICAL FIELD

The present disclosure relates to sizing and dewatering screens used in mineral processing applications. More specifically, and not by any way of limitation, at least some of the disclosed embodiments relate to monitoring screen health and performance.

### BACKGROUND

The sand and aggregate industry as well as the mining and mineral processing industry use heavy-duty vibratory screen systems (e.g., dewatering screens), to remove substances. Example applications include scalping oversized materials from suspensions and slurries (e.g., removing tramp metal from gold pulp, removing oversized materials from beach sand, and the like) dewatering and draining (e.g., dewatering activated carbon, tailings dewatering, and sand dewatering), and de-sliming (e.g., removing fines from activate carbon, removing fines from fine coal, and the like).

A typical vibratory screen system has an area that is several feet long, tall, and wide and operates at feed capacities of several metric tons per hour. Moreover, typical vibratory screen systems operate for long periods of time in harsh conditions (e.g., mining conditions). Due to the high cost of vibratory screen system component parts and the importance of quality control, it is desirable to automatically and/or electronically monitor the health and performance of various aspects of the vibratory screen systems. However, the vibratory screen system environment presents unique challenges to monitoring equipment.

One such challenge is the unusually high vibration environment of the screens themselves. For example, typical screens operate at acceleration amplitudes in ranges as high as 12 G to 15 G, with displacements almost as high as 10 mm and 1 inch. The repetitive movement, displacement, and jostling causes wear and tear on the wiring of traditional electronic monitoring components, for example, power cords and communication cables. While utilizing wireless sensors may alleviate some of the communication cabling problems, conventional wireless sensors require a power source. Unfortunately, the environments (e.g., mineral mines) and length of time in which vibratory screen systems operate are not conducive to conventional battery powered wireless sensors.

Conventional battery powered wireless sensors have considerable draw backs including battery replacement requirements. Upon depletion of one or more battery, either the sensor becomes worthless or operations of the vibratory screen system would be halted so that batteries could be replaced. Halting operations of a vibratory screen system to switch out sensor batteries causes production losses, which is cost prohibitive and time prohibitive.

Further, typical rechargeable battery powered wireless sensors do not solve this problem. When a battery of a wireless sensor depletes, typical battery recharging processes are impractical for the environment. Recharging batteries of the sensors using a power cable while a vibratory screen is vibrating is ineffectual because, as explained above, the vibrations and displacement of the vibratory screen system destroys power cords. Alternatively, halting operations of a vibratory screen system to safely plug in a power cable or swap out batteries cause production losses, which is cost prohibitive and time prohibitive. Moreover, the screens' operating environments (e.g., mining fields) suffer from scarce electrical power sources making conventional rechargeable batteries which rely typical power outlets for recharging impractical.

### SUMMARY

This summary is provided to introduce a selection of concepts in a simplified form that are further described below in the Detailed Description. This summary is not intended to identify key features or essential features of the claimed subject matter. Nor is it intended to be used as an aid in determining the scope of the claimed subject matter.

A first aspect is directed to a monitoring system for monitoring health and performance of a vibratory screen system. The monitoring system includes: a wireless sensor disposed on the vibratory screen system, the wireless sensor configured to collect measurements of the vibratory screen system; a wireless transmitter coupled to the wireless sensor configured to send the collected measurements of the sensor to a wirelessly coupled network; and an energy harvesting system coupled to the wireless sensor and the wireless transmitter and configured to provide power to the wireless sensor and the wireless transmitter, the energy harvesting system generating energy from motion of the vibratory screen system.

In some embodiments, a processor is operable to select a power source of a plurality of power sources based at least on an operating mode of the vibratory screen system, the selected power source powers the wireless sensor and the wireless transmitter.

In some embodiments, the selected the power source is the energy harvesting system while the vibratory screen system is in an ON operational mode, and the selected the power source is an energy storage device charged by the energy harvesting system while the operating mode of the vibratory screen system is in an OFF operational mode.

In some embodiments, the selected power source switched to a backup battery a charge of the energy storage device falling below a threshold level during the OFF mode.

Some aspects include a processor operable to control voltage input of the wireless sensor and the wireless transmitter based at least on an operating mode of the wireless sensor and the wireless transmitter.

In some embodiments, the controlled input voltage is controlled to a first voltage based on the vibratory screen system being in an OFF operational mode.

In some embodiments, the controlled input voltage is controlled to a second voltage based on the operating mode of the vibratory screen system being ON mode, the second voltage being higher than the first voltage.

In some embodiments, the wireless sensor collects at least one of: displacement measurements of the vibratory screen system; frequency measurements of the vibratory screen system; or temperature measurements of the vibratory screen system.

In some embodiments, the wireless coupled network includes a remote gateway, configured to at least: receive the transmission from the wireless transmitter; in response to receiving the transmission, indicate an acknowledgement; and send a second transmission to a remote computing environment, the second transmission being based on information of the first transmission, wherein the remote computing environment monitors the health and performance of the vibratory screen system.

In some embodiments, the energy harvesting system includes: a weight configured to tune output of the energy harvesting system to a range of Hertz.

In some embodiments, the energy harvesting system includes a housing having a T shaped cross bar at an exterior portion of the housing and one or more impact resistant bumpers.

Some aspects are directed to monitoring health and performance of a vibratory screen system. Such monitoring is performed, in some embodiments, through: collecting measurements of the vibratory screen system via one or more wireless sensor disposed on the vibratory screen system; sending, via a wireless transmitter coupled to the one or more sensor, the collected measurements of the one or more sensor to a gateway; and powering the one or more wireless sensor and wireless transmitter via a selected power source of a plurality of power sources, the plurality of power sources including an energy harvesting system that harvests energy from motion of the vibratory screen and a backup battery.

Some embodiments send a digital signal to a digital switch indicating the selected power source of the plurality of power sources based at least on a determined operating mode of the vibratory screen system.

In some embodiments, the vibratory screen system operates in ON and OFF operational modes. While the operating mode of the vibratory screen system is in the OFF mode, the selected the power source is an energy storage device charged by the energy harvesting system from the motion of the vibratory screen, and upon a charge of the energy storage device falling below a threshold level during the OFF mode, the selected power source is switched to the backup battery.

Some embodiments further control the input voltage of the one or more the wireless sensor and the wireless transmitter to a first voltage based on an operating mode of the vibratory screen system being in the OFF operational mode.

Some embodiments further control input voltage of the one or more the wireless sensor and the wireless transmitter to a second voltage based on an operating mode of the vibratory screen system being in the ON operational mode, the second voltage being higher than the first voltage.

Some embodiments further receive, by a gateway, a transmission from the wireless transmitter, and in response to receiving the transmission, indicate, by the gateway to the wireless transmitter, an acknowledgement thereof. Additionally, the gateway may send a second transmission to a remote computing device or environment monitoring the health and performance of the vibratory screen system, with the second transmission being based on information of the first transmission.

In some embodiments, the collected measurements of the vibratory screen system include at least one of frequency measurements and displacement measurements.

In some embodiments, the collected measurements of the vibratory screen system include temperature measurements.

Additional aspects are directed to a monitoring system for monitoring health and performance of a vibratory screen system. The monitoring system includes: a wireless sensor disposed on the vibratory screen system, the wireless sensor configured to collect measurements of the vibratory screen system; a wireless transmitter coupled to the wireless sensor configured to send the collected measurements of the sensor to a gateway of a wirelessly coupled network; and a plurality of selectable power sources configured to power the wireless sensor and the wireless transmitter. More specifically, the selectable power sources include: an energy harvesting system generating energy from motion of the vibratory screen system, an energy storage device storing surplus energy from the energy harvesting system, and a backup battery. Additionally, the monitoring system includes a digital switch configured to: switch to the energy harvesting system while an operational mode of the vibratory screen system is in ON mode, switch to the energy storage device while an operational mode of the vibratory screen system is in OFF mode, and upon a charge of the energy storage device falling below a threshold level while the operational mode is OFF mode, switch from the energy storage device to a backup battery.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

For a more complete understanding of the present invention, reference is now made to the following descriptions taken in conjunction with the accompanying drawings, in which:

FIG. 1A is an exemplary block diagram illustrating a computing environment for monitoring a vibratory screen.

FIG. 1B is another exemplary block diagram illustrating a computing environment for monitoring a vibratory screen.

FIG. 2 is an exemplary block diagram illustrating physical features of a measuring module.

FIG. 3 is another exemplary block diagram illustrating physical features of a measuring module.

FIG. 4 is an exemplary flow diagram illustrating an example process for monitoring a vibratory screen system.

FIG. 5 is an exemplary flow diagram illustrating an example process for monitoring a vibratory screen system.

FIG. 6 is an exemplary block diagram illustrating a block diagram of a cloud-based monitoring environment.

Corresponding reference characters indicate corresponding parts throughout the drawings.

### DETAILED DESCRIPTION

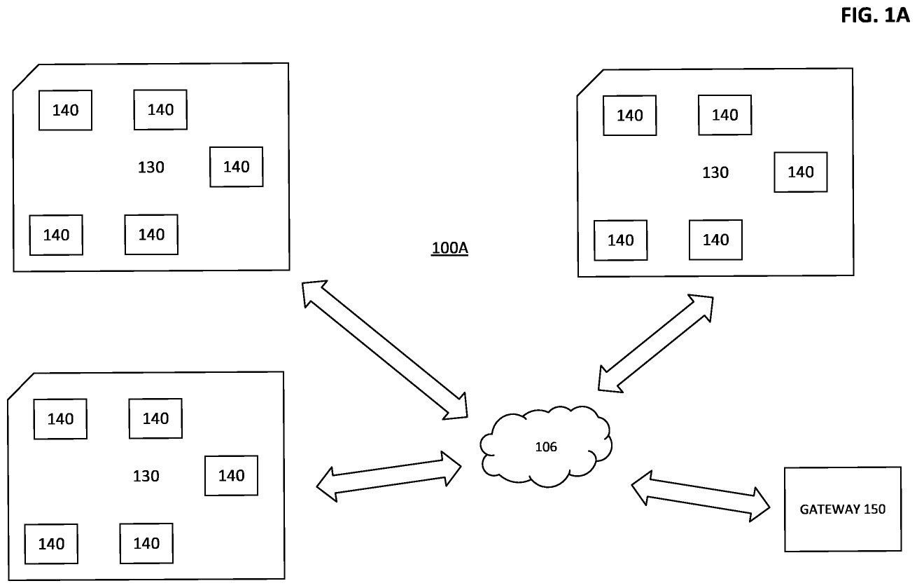

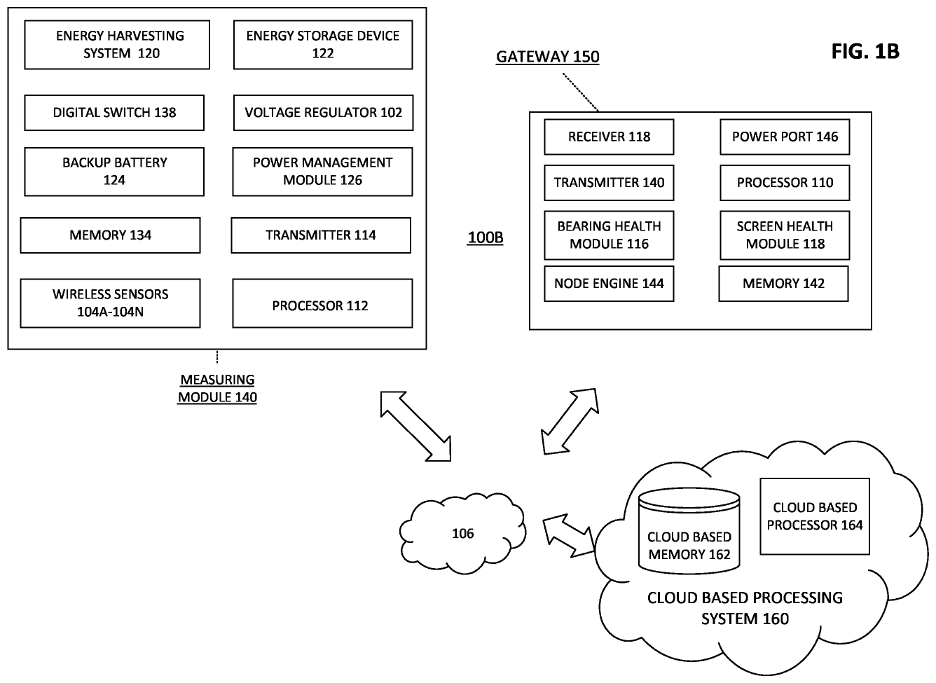

Aspects of the disclosure enable automatic electronic monitoring of the health and performance of vibratory screen systems. Systems and methods disclosed herein provide solutions for the harsh environment within which screen monitoring systems operate by, at least, avoiding communications cables and power cords as well as battery replacements. Also, some of the systems and methods disclosed herein extend the life span of aspects of the monitoring system at least by selectively choosing from a plurality of power sources based at least on a mode (e.g., ON mode, OFF mode, and the like) of a vibratory screen system. Further still, systems and methods disclosed herein extend the life span of aspects of the monitoring system at least by powering on and off selected components based on an operational state (e.g., active state, idle state, and the like) of a measuring module and additionally by adjusting idle state periods and/or active state operations based at least on a mode of the vibratory system. Referring to FIGS. 1A and 1B, an example computing environment 100A-100B is illustrated. In the exemplar of computing environment 100, one or more vibratory screen systems 130 are in wireless communication with a gateway 150 via wireless network 106. Each vibratory screen system 130 may have one or more measuring module 140 mounted at various locations therein. Measuring module 140 represents components parts of the electronic monitoring system that are mounted to a vibratory screen system 130. In some examples, a plurality of measuring modules 140 may be mounted on a single vibratory screen system 130. For example, one or more measuring module 140 may be mounted on or adjacent one or more screens of vibratory screen system 130, mounted at or near a feed input, mounted in bearing blocks, mounted in the drive systems, and/or the like.

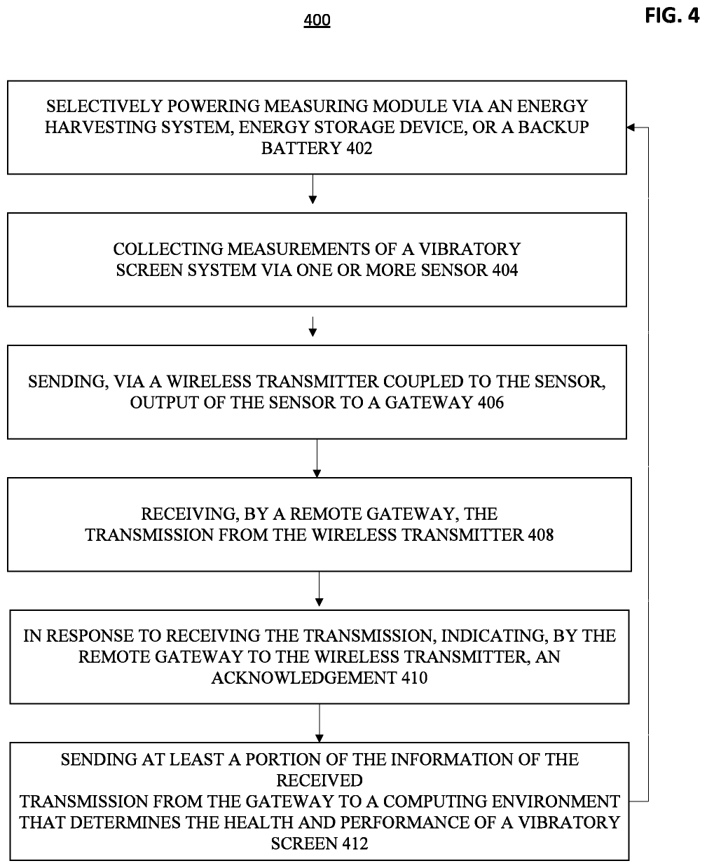

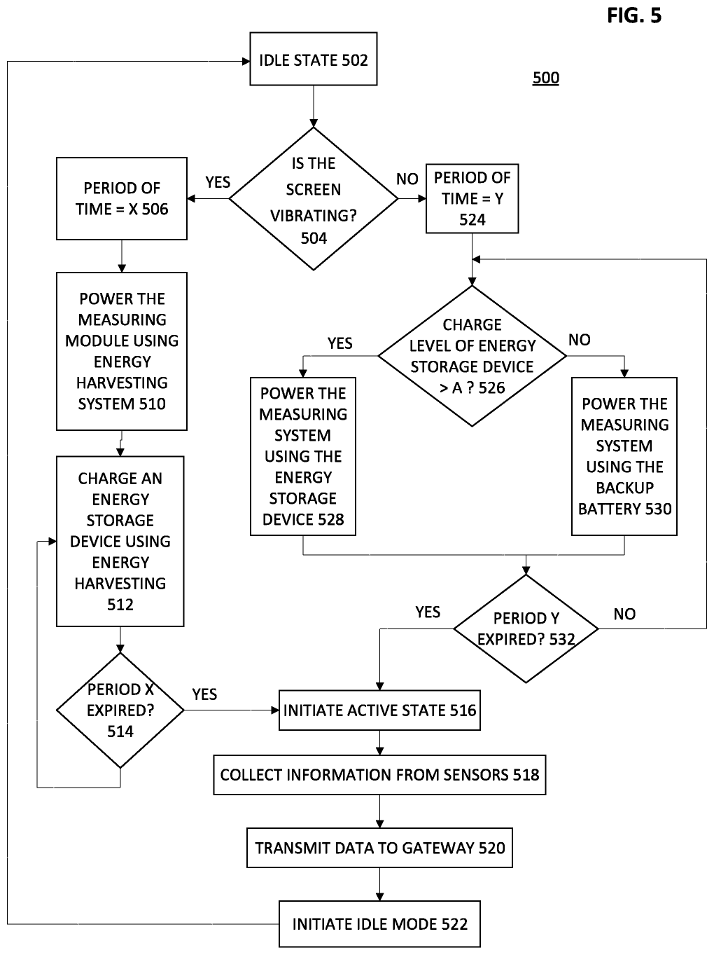

Each measuring module 140 includes one or more processors 112 (e.g., microprocessor) coupled to memory 134, which, for example, may include one or more computer-readable media. Example media storage include any quantity of media associated with or accessible by a processor. The memory may be internal to the measuring module 140 (as shown in FIG. 1B), external to the measuring module (not shown), or both (not shown). In some examples, the memory includes read-only memory and/or memory wired into an analog computing device. Processor 112 is programmed to execute computer-executable instructions stored in memory 134 for implementing aspects of the disclosure. The instructions may be performed by processor 112 or by multiple processors within measuring module 140 or performed by a processor external to the measuring module 140. In some examples, the processor 112 is programmed to execute instructions such as those illustrated in the figures (e.g., FIG. 4 and FIG. 5).

In some examples, the processor represents an implementation of analog techniques to perform the operations described herein. For example, the operations may be performed by an analog computing device and/or a digital computing device. Memory 134 may store, among other data, one or more applications. The applications, when executed by the processor, operate to perform functionality on the measuring module 140. The applications may communicate with counterpart applications at gateway 150 and/or cloud-based processing system 160. For example, the applications may represent downloaded measuring module applications that correspond to gateway applications and/or server-side applications executing in a cloud.

Each measuring module 140 may include one or more wireless sensors 104A-104N. Sensors 104 may include any combination of accelerometers, temperature sensors, proximity sensors, infrared sensors, laser sensors, pressure sensors, light sensors, ultrasonic sensors, and/or the like. A sensor 104 may be configured to measure a single parameter or may be configured to measure a plurality of parameters. Sensor configuration may be dynamic. A sensor 104 may measure parameters related to screen health, bearing health, and/or other features of the vibratory screen system.

Measuring module 140 communicatively couples each sensor to a wireless transmitter 114, which may be a transceiver. Transmitter 114 may communicate via radio frequency (RF), such as for, for example but without limitation, at 2.4 GHz. Other optional wireless communications of transmitter 114 include Bluetooth®, Zigbee™, cellular, Wi-Fi®, WiMax®, and/or the like. A sensor 104 may collect data and transmit the data via transmitter 114. For example, a measuring module 140 directed to screen health may transmit data related to peak feed, vertical and horizontal vibration levels, the running frequency of the screen, relative phase between the feed and vertical vibration signals absolute peak acceleration (e.g., x, y, z directions), root mean square (RMS)-based peak acceleration (e.g., x, y, z directions), fast Fourier transform (FFT)-derived dominant frequency of accelerometer signal (e.g., x, y, z directions), raw phase from FFT analysis (e.g., x, y, z directions), and when appropriate, dummy data. In another example, a measuring module 140 directed to bearing health of a vibratory screen system may include one or more temperature sensors and transmit temperature values and, when appropriate, dummy data. Each sensor 104 may be assigned a unique location and/or a unique identifier (e.g., MAC address, RF transmission channel, and/or the like). In examples, the unique identifier and/or unique location may be attached to transmitted sensor data. Including the unique identifier and/or unique location adds context to transmitted sensor data.

Measuring module 140 includes a plurality of power sources including energy harvesting system 120 (e.g., piezo-beam energy harvester). In operation, energy harvesting system 120 generates energy to power the components of measuring module 140 using the vibrations of the vibratory screen system 130 while the operational mode of the vibratory screen system 130 is ON mode. The vibratory screen system 130 is in the ON operational mode when the screen of the vibrational screen system is vibrating. In some embodiments, energy harvesting system 120 generates power in a vibration environment from about 10 Hz to about 15 Hz, at or substantially at 3 G to about 8 G with a displacement order of 0.75″. Alternatively, energy harvesting system 120 may operate outside these ranges as well.

Energy harvesting system 120 may operate independent of the screen's vibration being at a natural frequency of the piezo-beam. Further, energy harvesting system may operate regardless of beam tuning that matches the frequency of the vibratory screen system 130.

Energy storage device 122 is another of the plurality of power sources of measuring module 140. Energy storage device 122 stores excess power generated by energy harvesting system 120. An example energy storage device 122 is one or more IF supercapacitors. Energy storage device 122 discharges stored energy to power components of measuring module 140 while the vibratory screen system 130 is in the OFF operational mode. The vibratory screen system 130 is in the OFF mode when the screen of vibratory screen system is stationary and not vibrating.

Backup battery 124 is another of the plurality of power sources of measuring module 140. In some embodiments, backup battery 124 is one or more lithium batteries. Operationally, backup battery 124 discharges stored energy to power components of measuring module 140 while the vibratory screen system 130 is in OFF operational mode and the charge of energy storage device 122 is below a suitable threshold, threshold A. Threshold A may be defined to ensure that energy store device is charged with a sufficient amount of energy to power components of a measuring module 140 for a period of time. The value of threshold A may be contingent on the unique components of a particular measuring module 140, such that threshold A for one measuring module 140 may be configured differently from threshold A for another measuring module 140. Threshold A may be dynamically configurable.

Measuring module 140 may include one or more power management modules 126 that determine the vibratory screen system's operation mode and measuring module's operational state. For example, measuring module 140 may determine whether energy harvesting system 120 is generating power, whether vibratory screen system 130 is in the ON or OFF operational modes, whether measuring module 140 is active or idle, a charge level of energy storage device 122, and/or the like. Further, measuring module 140 may also include one or more voltage regulator 102, which selectively controls an amount of voltage provided to components of measuring module 140 based at least on a determined operation state of measuring module 140 (e.g., active state, idle state, and the like).

In an example, voltage regulator 102 may be configured to supply a first voltage (e.g., from about 3 to about 3.3V) to measuring module 140 base on a determination by power management module 126 that energy harvesting system 120 is not currently generating power (e.g., while vibratory screen system 130 is in OFF operational mode). The first voltage may be set at a value that is sufficient for measuring module 140 to operate in an active state. Further, voltage regulator 102 may be configured to supply a second voltage (e.g., about 4.5V) to measuring module 140 based on a determination that energy harvesting system 120 is currently generating power (e.g., while vibratory screen system 130 is in ON operational mode). The second voltage may be set at a value that is higher than the first voltage thereby resulting in a voltage surplus (e.g., about 1.5V). Energy storage device 122 may be connected to the Vout of energy harvesting system 120 such that the voltage surplus charges energy storage device 122 while energy harvesting system 120 is generating power (e.g., while vibratory screen system 130 is in ON operational mode). Additionally, in some embodiments, when energy harvesting system 120 is not generating power (e.g., while vibratory screen system 130 is in OFF operational mode), voltage regulator 102 down shifts the voltage input of measuring module 140 to the first voltage. As such, the circuitry of measuring module 140 receives a stable first voltage (e.g., from at or substantially about 3V to 3.3V) regardless of the output of energy harvesting system 120, and energy storage device 122 charges while energy harvesting system 120 is actively generating power.

Measuring module 140 may also include one or more switches 138 (e.g., a J8 jumper). Switch 138 may selectively switch between two or more of the power sources based at least on a determination that energy harvesting system 120 is generating power (e.g., while vibratory screen system 130 is in ON operational mode). Mechanical switches may be used in some embodiments, or digital switches may alternatively be used due to the high vibration acceleration of vibratory screen system 130. For the sake of clarity, reference is made below to the switches being digital switches; though, mechanical switches may be used instead.

In some examples, digital switch 138 switches to energy harvesting system 120 based, at least, on a determination by power management module 126 that energy harvesting system 120 is generating power (e.g., while vibratory screen system 130 is in ON operational mode), thereby causing measuring module 140 to receive power from the energy harvesting system 120. Additionally, the digital switch 138 switches to one of the alternative power sources based, at least, on a determination that energy harvesting system 120 is not generating power (e.g., while vibratory screen system 130 is in OFF operational mode).

For example, based on a determination that energy storage device 122 is charged with at least a threshold A amount of energy, digital switch 138 switches to energy storage device 122 causing measuring module 140 to receive power from energy storage device 122. Alternatively, based on a determination that energy storage device 122 is depleted below a threshold A amount of energy, digital switch 138 switches to backup battery 124 causing measuring module 140 to receive power from backup battery 124. During the life of measuring module 140, digital switch 138 may switch to and from any of the power sources as energy harvesting system 120 turns on and off and energy storage device 122 fills and depletes, thereby allowing monitoring module 140 to operate while avoiding power cords as well as battery replacements.

Measuring module 140 communicates—either unidirectionally or bidirectionally—with gateway 150 via wireless network 106. For example, data collected by sensors 104 may be sent by transmitter 114 of measuring module 140 to receiver 118 of gateway 150. Further, data (e.g., configuration data, firmware, updates, etc.) may be sent by transmitter 140 to a receiver (not shown) of measuring module 140. Gateway 150 may receive information from a plurality of measuring modules 140 located throughout, or embedded within, a plurality of vibratory screens 130 in various mining or industrial equipment. In examples, a data packet may be transmitted repeatedly until an acknowledgement is received in the opposite direction such that interference, packet collisions, and the like are resolved.

Gateway 150 is located remotely from vibratory screen system 130, often in a gentler environment free from excessive vibrations. As such, cable and cord destruction are of less concern, and gateway 150 may be powered by a power cable coupled to power port 146, if desired.

Gateway 150 also includes one or more memory 142, which for examples may include one or more computer readable media. Example media storage includes any quantity of media associated with or accessible by a processor. The memory may be internal to the gateway 150 (as shown in FIG. 1B), external to the gateway (not shown), or both (not shown). In some examples, the memory includes random access memory (RAM), read-only memory (ROM), flash memory, and/or memory wired into an analog computing device. Processor 110 is programmed to execute computer-executable instructions stored in memory 134 for implementing aspects of the disclosure. The instructions may be performed by processor 110 or by multiple processors within gateway 150 or performed by a processor external to the gateway 150. In some examples, the processor 110 is programmed to execute instructions such as those illustrated in the figures (e.g., FIG. 4 and FIG. 5).

In examples, memory 142 is configured such that one or more processor 110 executes to provide screen health module 118 and bearing health module 116. Upon receiving data from measuring module 140, processor 110 determines the source and/or contents of the data and directs the data to screen health module 118 and/or bearing health module 116 as is appropriate. As explained above, each sensor 104 may be assigned a unique location and/or unique identifier, and the unique location and/or unique identifier is appended to data transmissions that include data measurements collected by the identified sensor. When gateway 150 receives a data transmission, the data packet includes the unique location and/or unique identifier of the sensor that collected the data. Using the unique location and/or unique identifier, gateway 150 identifies the source of the data and determines whether the data is related to screen health, bearing health, and/or both. Upon determining the relevancy of the data, gateway 150 sends the data (e.g., measurements and/or the location/identifier information) to the screen health module 118, bearing health module 116, and/or both for processing.

Screen health module 118 receives and processes data related to the health of a screen of the vibratory screen system 130. Bearing health module 116 receives and processes data related to the health of bearings of the vibratory screen system 130. In examples, a single module may be configured to perform the functions of both screen health module 118 and bearing health module 116. Some or all of the measured data may be processed by measuring module 140, if desired, but preferably, the measured data is processed at gateway 150. For example, wireless communication channels may function as a wireless serial cable allowing data printed to the serial port at measuring module 140 to be transmitted wirelessly to a serial port at gateway 150. Sending raw data to gateway 150 for processing reduces processing power and reduces the amount of time measuring module 140 is in an active state, thereby conserving the energy of measuring module 140.

Measured data may be sent in binary format, if desired, using a 16-bit signed integer. Based on the received data, screen health module 118 and/or bearing health module 116 may calculate speed (e.g., in hertz), any relative phase, absolute peak acceleration, RMS-based peak acceleration, FFT-derived domain frequency, peak vibration, temperatures, and any changes thereof over time. The acceleration values may be received in raw binary format. Frequency data may be the FFT-derived frequency (in Hz) multiplied by 100 (yielding values to the nearest 0.01 Hz), and phase data may be phase (in degrees) multiplied by 100 (yielding values to the nearest 0.01 degrees). Temperature data may also be a 16-bit signed integer reporting temperature multiplied by 10 (yielding temperature readings to the nearest 0.1 degrees). Other information may be transmitted unsigned byte data as appropriate. In examples, dummy data may be sent so that data packets remain the same size regardless of the measurements included therein.

During processing, screen health module 118 and/or bearing health module 116 calculates performance and may additionally convert the received unique identifiers and/or unique locations to link each data set to a particular work site 100A, a location within the work site 100A, and/or a specific location on a particular vibratory screen system 130. Once linked, the linked data may be sent to node engine 144, which prepares the data for transmission to a cloud based processing system 160 for additional processing by one or more cloud based processor 164 and/or storage in cloud based memory 162 (e.g., database).

In order to further reduce power expenditures of measuring module 140, measuring module 140 may periodically cycle through active states and idle states. In examples, measuring module 140 is in active state while waking up, collecting measurements, and transmitting and/or receiving data. Alternatively, measuring module 140 powers down into an idle state, wherein various components are powered down (e.g., transmitter 114, wireless sensors 104, and the like) but other components are still receiving enough power to perform certain functions (e.g., process a wakeup signal, track time periods, and the like).

Measuring module 140 may cycle between states according to periods of time. For example, while vibratory screen system 130 is in ON mode, measuring module 140 may start active state every X minutes (e.g., 5 minutes). Upon the expiration of X minutes, processor 112 receives a wake up signal and performs wakeup procedures, wherein particular components may be powered up. In examples, while in active state, power management module 126 determines whether vibratory screen system 130 is actively vibrating. In examples, if power management module 126 detects that vibratory screen system 130 is stationary, measuring module 140 may bypass data collection procedures and transmit dummy data and/or status data indicating that measuring module 140 is operational but data collection not desired at the moment. Bypassing data collection procedures saves processing energy and allows powering down to begin more quickly thereby conserving additional energy.

In examples, if power management module 126 detects movement of vibratory screen system 130, wireless sensors 104A-104N perform data collection. Measurements may be performed in a particular order in order to strategically keep the active state short. In some embodiments, when an accelerometer is configured to collect measurements for a full second of time, a thermometer measurement is initiated, then the accelerometer is read during the time the thermometer is generating its data, and then the thermometer data is read.

Collected data is transmitted by transmitter 114, and measuring module 140 waits for an acknowledgment (ACK) message from gateway 150 for every transmitted data packet. If an ACK message is not received for one or more data packet, transmitter 114 may resend the respective data packet or packets. Thereafter, measuring module 140 enters idle state by powering down some of the components thereby saving energy. After measuring module 140 enters idle mode, measuring module 140 remains in idle state for X minutes and then cycles back into active state.

Measuring module 140 cycles between active state and idle state on comparatively short intervals (e.g., 1 minute, 5 minutes, 10 minutes, etc.) when frequent monitoring is desired, for example, while vibratory screen system 130 is in ON mode. However, sometimes less frequent monitoring may be desired, for example, while vibratory screen system 130 is in OFF mode. In examples, measuring module 140 determines that vibratory screen system 130 is in OFF mode, for example, based on detecting a lack of movement during two consecutive periods. Based on the determination that vibratory screen system 130 is in OFF mode, measuring module 140 may lengthen the idle state period to Y minutes, wherein Y minutes is more than X minutes. For example, the idle state time period may be extended to 12 hours or any desired amount of time. In this example, measuring modules 140 cycles between active state and idle state once every 12 hours thereby saving additional energy by preventing power expenditures caused by the active state. Upon determining that vibratory screen system 130 is in ON mode (e.g., by detecting movement during an active state), measuring module 140 may shorten the idle state period back to X minutes. Further details regarding processes of monitoring the health and performance one or more vibratory screen system 130 are provided below with respect to FIGS. 4 and 5.

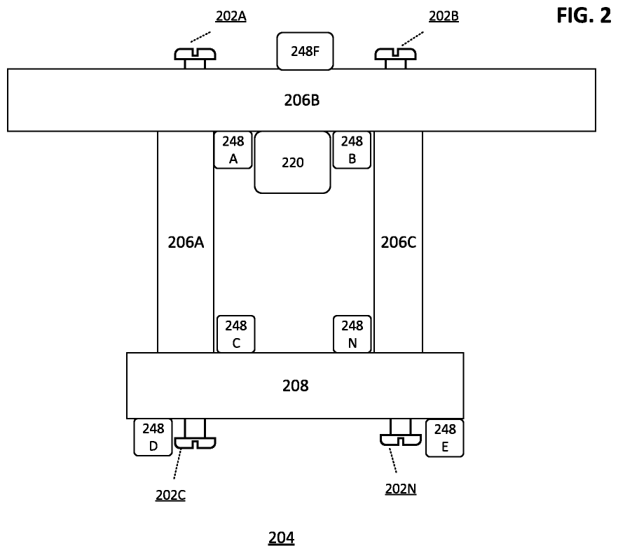

FIG. 2 illustrates an example structural view of a measuring module 140. Measuring module 140 may include housing 204, which protects component parts of measuring module 140 from damage and mounts measuring module 140 to vibratory screen system 130. Example housing 204 is shown as an open housing having a “U” shaped bracket (206A-206C) affixed to a horizontal base 208 thereby providing an open box surrounding at least the features of measuring module 104 described in FIGS. 1A-1B. An alternative example housing (not shown) may provide an enclosure, if additional protection is desired.

In examples, some or all of housing 204 may be made of a nonmetallic material to prevent radio interference, but some or all of housing 204 may include metal materials if desired. Energy harvesting system 220 is shown affixed to housing 204. While not shown, all components of measuring module 140 described in FIGS. 1A and 1B may be affixed within housing 204. Fasteners 202A-202N may mount housing 204 to vibratory screen system 130, and any number of fasteners 202A-202N may be distributed at various locations of housing 204. Some or all fasteners 202A-202N may be nonmetallic to prevent radio interference, but one or more fasteners 202A-202N may include metal materials if desired. In examples, housing 204 may be mounted to vibratory screen system 130 such that energy harvesting system 220 is perpendicular to screen motion.

Some housings include a “T” shaped crossbar providing mass which tunes the vibration frequency to a desired range (e.g., from about 20 to about 30 Hz). Further, providing an elongated “T” structure prevents twisting that could otherwise cause long-term failure and minimizes collection distortions. Housing 204 also provides a firm structure against which component parts of measuring module 140 may bump during oscillations, and impact resistant bumpers 248A-248N provide sufficient cushion when bumping occurs. In examples, impact resistant bumpers 248A-248N may include rubber and may be positioned throughout housing 204.

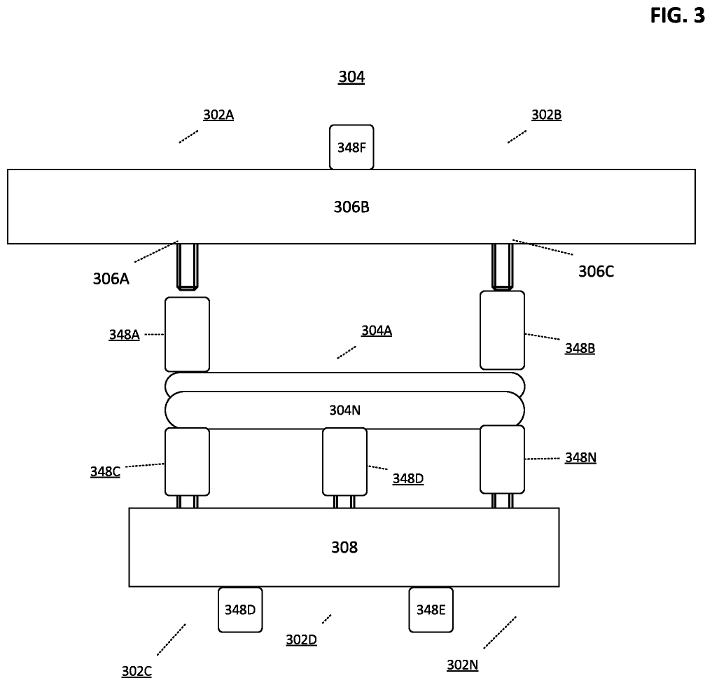

FIG. 3 illustrates an example structure of a measuring module 140 from a different viewing perspective. Example housing 304 includes “U” bracket 306A-306C, which affixes to base 308. Weights 304A-304N may be included within housing to tune the vibratory frequency to an energy harvesting range (e.g., from about 20 to about 30 Hz). Fasteners 302A-302N may couple housing 304 to any desired location of vibratory screen system 130, and impact resistant bumpers may protect from damage and twisting.

FIG. 4 illustrates an example process 400 of monitoring the health and performance one or more vibratory screen system 130. At step 402, measuring module 140 powers components of measuring module 140 selectively using one of energy harvesting system 120, energy storage device 122, and backup battery 124. At step 404, measuring module 140 collects measurements of vibratory screen system 130 using one or more sensors 104A-104N. At step 406, the collected measurements are wirelessly transmitted by a transmitter 114 coupled to the sensors 104A-104N. At step 408, a gateway 150 receives the wireless transmission. At step 410, in response to receiving the wireless transmission, gateway 150 sends an acknowledgement transmission to measuring module 140. At step 412, after gateway 150 has processed some or all of the received wireless transmission, gateway 150 sends at least of portion of the information received from measuring module 140 to a remote computing environment (e.g. cloud computing environment 160), which monitors the health and performance of one or more vibratory screen system 130.

FIG. 5 illustrates an example process 500 of monitoring the health and performance one or more vibratory screen system 130 using techniques that maximize power conservation. Measuring module 140 may be configured to default to an idle state. At step 502, measuring module 140 is in idle state, wherein some components of measuring module 140 are powered down and other components (e.g., power management module 126) of measuring module 140 may be powered with a minimal amount of power sufficient to continue operations while in idle state. At step 504, power management module 126 determines whether vibratory screen system 130 is vibrating. If vibratory screen 130 is vibrating, step 506 sets the idle state time period X, which is a shorter time period as compared to Y. If at step 506, the time period is already set at X, step 506 may be skipped.

At step 510, power management module 126 decides to power measuring module 140 via energy harvesting system 120. As explained above, if at step 510 measuring module 140 is currently being powered by an energy source other than energy harvesting system 120, then a signal is sent to digital switch 138 indicating that the power source should be switched to energy harvesting system 120. However, if at step 510 measuring module 140 is already being powered by energy harvesting system 120, then signaling digital switch 138 may be skipped.

At step 512, surplus energy from energy harvesting system 120 charges one or more energy storage device 122. For example, voltage regulator 102 determines the Vout of energy harvesting system 120. If Vout is higher than the configured power input of measuring module 140, then the surplus voltage is used to charge one or more energy storage device 122. If, however, voltage regulator 102 determines that Vout is not higher than the configured power input of measuring module 140, then voltage regulator 102 increases Vout to be higher than the configured power input of measuring module 140, and then the surplus voltage is used to charge one or more energy storage device 122.

At step 514, power management module 126 determines whether time period X has expired. If time period X has not yet expired, the process moves back to step 512. If at step 514, time period X has expired, the process moves to step 516, which initiates active state of measuring module 140 by powering on components thereof At step 518, measurements from sensors 104A-104N are collected (as explained above), and transmitter 114 transmits the collected data to gateway 150 at step 520. In examples, transmissions are repeated until an acknowledgement is received from gateway 150 thereby ensuring the data is successfully transmitted. At step 522, idle mode is initiated and the process returns to step 502.

At step 502, the process moves to step 504, wherein power management module 126 determines whether vibratory screen system 130 is vibrating. In this example, step 504 determines that vibratory screen system 130 is stationary and moves to step 524. Step 524 sets the idle time period Y, which is a longer time period as compared to X (e.g., X=5 minutes and Y=12 hours). If at step 524, idle time period is already set at Y, step 524 may be skipped. Further, in some examples, power management module 126 waits until the determination at step 504 indicates vibratory screen system 130 is stationary for two consecutive idle times periods before setting the idle time period to Y.

At step 526, power management module 126 determines whether the charge level of one or more energy storage device 122 is greater than a threshold A. Threshold A may be equal to an amount of energy sufficient to power measuring module 140 for a period of time (e.g., Y period of time). If step 526 determines that one or more energy storage device 122 is greater than a threshold A, the process moves to step 528 wherein power management module 126 decides to power measuring module 140 via one or more energy storage device 122. If energy storage device 122 is not already powering measuring module 140, then digital switch 138 switches the power source to one or more energy storage device 122. If at step 526, power management module 126 determines that one or more energy storage device 122 is not greater than a threshold A, the process moves to step 530, wherein power management module 126 decides to power measuring module 140 via backup battery 124. If backup battery 124 is not already powering measuring module 140, then digital switch 138 switches the power source to backup battery 124.

At step 532, power management module 126 determines whether time period Y has expired. If time period Y has not yet expired, then the process returns to step 526. If at step 532 the time period Y has expired, the process moves to step 516, wherein active state is initiated. After initiation of measuring module 140 into active state, the process moves to step 518, wherein information is collected from sensors 104A-104N. In this example, the vibratory screen system 130 is not vibrating. The sensors may collect actual values (e.g., temperature, vibration speed, etc.). Additionally and/or alternatively, at step 518, instead of expending time and processing power collecting measurements of a vibratory screen system 130 that may be in an OFF mode, step 518 may collect dummy data that serves as data packet place holders. In some examples, bytes that are expected to hold data of minimal value because vibratory screen system 130 is stationary (e.g., vibration speed data) may include dummy data, while bytes that hold data that may be of value (e.g., temperature data indicating cool down rates) may include actual values. At step 520, transmitter 114 transmits the collected information to gateway 150. Thereafter, at step 522, measuring module 104 initiates idle mode 522 and returns to step 502.

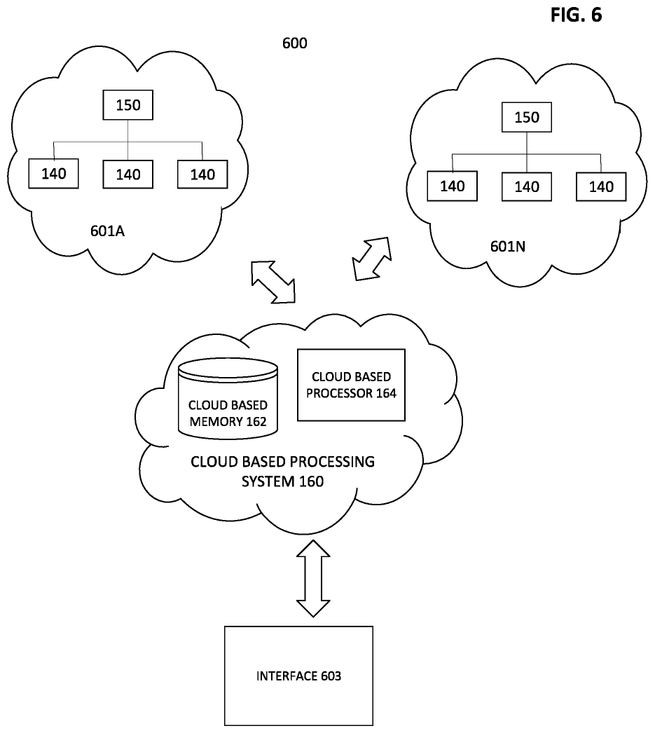

FIG. 6 is an exemplary diagram illustrating systems and methods of monitoring vibratory screen systems 130 operating with a cloud-based service. Example distributed monitoring may be implemented in a cloud-based environment 600, with one or more operations performed in the cloud 160, for example, some or all operations of bearing health module 116, screen health module 118, power management module 126, configurations, and other modules' operations. In this illustrative example, cloud-based processing system 160 may include virtual server 164, which may process any of the operations disclosed herein and/or store information from the operations disclosed herein in one or more exemplary database (e.g., using memory 162).

Monitoring environments 601A-601N may be communicatively coupled to cloud based processing system 160 via a communication network, or other network, to receive and/or obtain information from measuring modules 140 and/or gateway 150. The granularity of monitoring environments 601A-601N may be dynamically configured to represent a fleet of measuring modules 140, for example, according to identified work sites, geographic regions, and/or the like. In examples, virtual server 164 may provide and/or dynamically configure some or all operations, such as those depicted in FIGS. 4-5 for example. Cloud based processor 164 may processes, correlate, and compare data collected from a plurality of monitoring environments 601A-601N, which may be distributed geographically. Cloud based processor 164 may perform analytics and statistical analysis monitoring vibratory screen systems' health and performance over a period of time and store the information in cloud based memory 162. The monitored information may be used to identify current issues, determine causes of issues, record past issues, project potential future issues, correlate issues, track equipment inventory, and the like. A user may use interface 603 (e.g., a mobile device) to view monitored data sorted according to location, time, and the like, as well as analytical data to alert to various conditions in the monitored vibratory screens systems.

### ADDITIONAL EXAMPLES

An example monitoring system and method for monitoring health and performance of a vibratory screen system may include a measuring module that includes a wireless sensor disposed on the vibratory screen system. The wireless sensor may be configured to collect measurements of the vibratory screen system while also charging the wireless sensor through movements of the vibratory screen system. The example measuring module may further include a wireless transmitter coupled to the wireless sensor and configured to send collected measurements of the sensor to a gateway of a wirelessly coupled network.

The measuring module may also include a plurality of selectable power sources configured to power the wireless sensor and the wireless transmitter. Different power sources may have advantages and disadvantages depending on the operation mode of the vibratory screen system, and the example system may select one power source over another based at least on a determined operation mode of the vibratory screen system. The selectable power sources may include an energy harvesting system generating energy from motion of the vibratory screen system, an energy storage device storing surplus energy from the energy harvesting system, and a backup battery. A digital switch switches between the power sources. For example, the digital switch switches to the energy harvesting system while an operational mode of the vibratory screen system is in ON mode. Further, the digital switch switched to the energy storage device while an operational mode of the vibratory screen system is in OFF mode, and upon a charge of the energy storage device falling below a threshold level while the operational mode is OFF mode, the digital switch switches from the energy storage device to a backup battery. Providing a variety of power sources to the sensors and selecting a respective power source based at least on the mode of operation of the vibratory screen allows the system to avoid the use of power cords, avoid battery replacements, and prolong the life of the wireless sensors.

An example system may also include a remote gateway which receives the collect measurements from the wireless transmitter. To ensure error free transmissions, the gateway may send an acknowledgement to the wireless transmitter in response to receiving the transmission. Further, after having received the transmission, the gateway generates a second transmission based off information of the received transmission, send the second transmission to a remote computing environment that also monitors the health and performance of vibratory screen systems. Such a design may be used to off load some processing expenditures of the processor located near the wireless sensors resulting in energy savings at the data collection site, which is located where power cords are being avoided.

The gateway may be remote from the vibratory screen system in an environment that is conducive to power cords, and as such, power conservation is less imperative as compared to the data collection site, which includes the wireless sensors. Further, sending the processed information from gateway to a remote computing environment (e.g., cloud processing) may provide for faster computing times by more powerful processors, distributed access to the monitoring information, data redundancy, and correlation of monitoring information over periods of time and/or across geographical locations which leads to improved model projections and analytics due an increased data sample.

The example processor may also control the operating power of the system components based at least on the operating state of the wireless sensor and wireless transmitter of a measuring module. For example, while the sensors are in an idle state, the processor may power down the sensors and/or transmitter to save energy. Further, while in an active state, the processor may selectively power on one or more of the system components, and the sensors may collect measurements and send information in a particular order. Selectively controlling the power distribution to components of the system effectively prolongs the energy life of the energy storage device and the backup battery thereby extending the life at a measuring module.

Example embodiments collect at least one or more of displacement measurements of the vibratory screen; frequency measurements of the vibratory screen; and temperature measurements of the vibratory screen. Collecting these measurements provides robust data from which a screen health module and/or a bearing health module can monitor the health and performance of the vibratory screen.

In some systems and methods, the energy harvesting system may include one or more weights configured to tune output of the energy harvesting system to a range of hertz. Providing one or more weights may mitigate the unusually high vibration frequencies of the vibratory screens systems, which may otherwise interfere with the energy harvesting systems effective powering of components. Further, the housing of a measuring module may include at least one of a T shaped cross bar at an exterior portion of the housing and one or more impact resistant bumpers. Such a design reduces twisting, reduces linear jostling, and cushions impacts thereby preventing structural damage that could cause the measuring module to fail.

The examples illustrated and described herein as well as examples not specifically described herein but within the scope of aspects of the disclosure constitute an exemplary inventory management environment. For example, the elements illustrated in FIGS. 1-3 and FIG. 6, such as when encoded to perform the operations illustrated in FIGS. 4-5, constitute exemplary means for performing operations disclosed herein.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Although the terms “step” and/or “block” may be used herein to connote different elements of methods employed, the terms should not be interpreted as implying any particular order among or between various steps herein disclosed unless and except when the order of individual steps is explicitly described. The order of execution or performance of the operations in examples of the disclosure illustrated and described herein is not essential, unless otherwise specified. The operations may be performed in any order, unless otherwise specified, and examples of the disclosure may include additional or fewer operations than those disclosed herein. It is therefore contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. For example, in this specification, the word “comprising” is to be understood in its “open” sense, that is, in the sense of “including,” and thus not limited to its “closed” sense, that is the sense of “consisting only of.” A corresponding meaning is to be attributed to the corresponding words “comprise,” “comprised,” “comprises,” “having,” “has,” “includes,” and “including” where they appear. The term “exemplary” is intended to mean “an example of.” The phrase “one or more of the following: A, B, and C” means “at least one of A and/or at least one of B and/or at least one of C.” Moreover, in the following claims, the terms “first,” “second,” “third,” and “fourth,” etc. are used merely as labels, and are not intended to impose numerical requirements on their objects.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A monitoring system for monitoring health and performance of a vibratory screen system, the monitoring system comprising:
a wireless sensor disposed on the vibratory screen system, the wireless sensor configured to collect measurements of the vibratory screen system;
a wireless transmitter coupled to the wireless sensor configured to send the collected measurements of the sensor to a wirelessly coupled network; and
an energy harvesting system coupled to the wireless sensor and the wireless transmitter and configured to provide power to the wireless sensor and the wireless transmitter, the energy harvesting system generating energy from motion of the vibratory screen system.

2. The monitoring system of claim 1 further comprising: a processor operable to select a power source of a plurality of power sources based at least on an operating mode of the vibratory screen system, the selected power source powers the wireless sensor and the wireless transmitter.

3. The monitoring system of claim 1 wherein the selected power source is the energy harvesting system while the vibratory screen system is in an ON operational mode, and
wherein the selected the power source is an energy storage device charged by the energy harvesting system while the operating mode of the vibratory screen system is in an OFF operational mode.

4. The monitoring system of claim 3 wherein upon a charge of the energy storage device falling below a threshold level during the OFF mode, the selected power source switched to a backup battery.

5. The monitoring system of claim 1 further comprising: a processor operable to control voltage input of the wireless sensor and the wireless transmitter based at least on an operating mode of the wireless sensor and the wireless transmitter.

6. The monitoring system of claim 5 wherein the controlled input voltage is controlled to a first voltage based on the vibratory screen system being in an OFF operational mode.

7. The monitoring system of claim 5 wherein the controlled input voltage is controlled to a second voltage based on the operating mode of the vibratory screen system being ON mode, the second voltage being higher than the first voltage.

8. The monitoring system of claim 1 wherein the wireless sensor collects at least one of:
displacement measurements of the vibratory screen system;
frequency measurements of the vibratory screen system; or
temperature measurements of the vibratory screen system.

9. The monitoring system of claim 1 wherein the wireless coupled network comprises a remote gateway, wherein the remote gateway is configured to at least:
receive the transmission from the wireless transmitter;
in response to receiving the transmission, indicate an acknowledgement; and
send a second transmission to a remote computing environment, the second transmission being based on information of the first transmission, wherein the remote computing environment monitors the health and performance of the vibratory screen system.

10. The monitoring system of claim 1 wherein the energy harvesting system comprises:
a weight configured to tune output of the energy harvesting system to a range of Hertz.

11. The system of claim 1 wherein the energy harvesting system comprises a housing including at least:
a T shaped cross bar at an exterior portion of the housing; and
one or more impact resistant bumpers.

12. A method of monitoring health and performance of a vibratory screen system, the method comprising:
collecting measurements of the vibratory screen system via one or more wireless sensor disposed on the vibratory screen system;
sending, via a wireless transmitter coupled to the one or more sensor, the collected measurements of the one or more sensor to a gateway; and
powering the one or more wireless sensor and wireless transmitter via a selected power source of a plurality of power sources, the plurality of power sources including an energy harvesting system that harvests energy from motion of the vibratory screen and a backup battery.

13. The method of claim 12 further comprising:
based at least on a determined operating mode of the vibratory screen system, sending a digital signal to a digital switch indicating the selected power source of the plurality of power sources.

14. The method of claim 13 further comprising operating the vibratory screen system in ON and OFF operational modes, wherein:
while the operating mode of the vibratory screen system is in the OFF mode, the selected the power source is an energy storage device charged by the energy harvesting system from the motion of the vibratory screen, and
wherein upon a charge of the energy storage device falling below a threshold level during OFF mode, the selected power source is switched to the backup battery.

15. The method of claim 12 further comprising:
controlling input voltage of the one or more the wireless sensor and the wireless transmitter to a first voltage based on an operating mode of the vibratory screen system being in the OFF operational mode.

16. The method of claim 15 further comprising:
controlling input voltage of the one or more the wireless sensor and the wireless transmitter to a second voltage based on an operating mode of the vibratory screen system being in the ON operational mode, the second voltage being higher than the first voltage.

17. The method of claim 12 further comprising:
receiving, by the gateway, the transmission from the wireless transmitter;
in response to receiving the transmission, indicating, by the gateway to the wireless transmitter, an acknowledgement; and
sending, by the gateway, a second transmission to a remote computing environment, the second transmission being based on information of the first transmission, wherein the remote computing environment monitors the health and performance of the vibratory screen system.

18. The method of claim 12 wherein the collected measurements of the vibratory screen system include at least one of frequency measurements and displacement measurements.

19. The method of claim 12 wherein the collected measurements of the vibratory screen system include temperature measurements.

20. A monitoring system for monitoring health and performance of a vibratory screen system, the monitoring system comprising:
a wireless sensor disposed on the vibratory screen system, the wireless sensor configured to collect measurements of the vibratory screen system;
a wireless transmitter coupled to the wireless sensor configured to send the collected measurements of the sensor to a gateway of a wirelessly coupled network;
a plurality of selectable power sources configured to power the wireless sensor and the wireless transmitter, the selectable power sources including:
an energy harvesting system generating energy from motion of the vibratory screen system,
an energy storage device storing surplus energy from the energy harvesting system, and
a backup battery; and
a digital switch configured to:
switch to the energy harvesting system while an operational mode of the vibratory screen system is in an ON operational mode,
switch to the energy storage device while an operational mode of the vibratory screen system is in an OFF operational mode, and
upon a charge of the energy storage device falling below a threshold level while the operational mode is in the OFF operational mode, switch from the energy storage device to a backup battery.
